(19) United States
(12) Patent Application Publication
(10) Pub. No.: US 2026/0211658 A1
(43) Pub. Date: Jul. 23, 2026

(54) DATA MANAGEMENT DEVICE AND DATA MANAGEMENT METHOD

(71) Applicant: ASMedia Technology Inc., New Taipei City (TW)

(72) Inventor: Chun-Jung Hsu, New Taipei City (TW)

(73) Assignee: ASMedia Technology Inc., New Taipei City (TW)

(21) Appl. No.: 19/056,709

(22) Filed: Feb. 18, 2025

(30) Foreign Application Priority Data
Jan. 22, 2025 (TW) 114102854

(51) Int. Cl. G06F 8/65; G06F 8/71

(52) U.S. Cl. CPC G06F 8/65; G06F 8/71

(57) ABSTRACT

Provided is a data management method, including: an external version information is provided to a first controller, the external version information corresponds to a data portion stored by a storage circuit in a host device, and the data portion corresponds to a host version information; and an update trigger signal is generated by the first controller according to the external version information and the host version information, and an application is triggered to update the data portion by the update trigger signal.

### CROSS-REFERENCE TO RELATED APPLICATION

This application claims the priority benefit of Taiwan application serial no. 114102854, filed on January 22, 2025. The entirety of the above-mentioned patent application is hereby incorporated by reference herein and made a part of this specification.

### BACKGROUND

### Technical Field

The disclosure relates to a data management device and a data management method, and in particular relates to a data management device and a data management method configured to update data.

### Related Art

In today's information-rich era, due to the rapid turnover of information, updating data stored in an electronic device is necessary. However, updating data in a storage circuit, such as a read-only memory (ROM), often needs manual execution of an application, which may cause considerable inconvenience to a user. Therefore, developing a data management device and a data management method which can automatically update data is indispensable.

### SUMMARY

The disclosure provides a data management device and a data management method, which can timely and automatically update data in a storage circuit, such as data in a read-only memory (ROM).

The data management method of the disclosure includes: an external version information is provided to a first controller, the external version information corresponds to a data portion stored by a storage circuit in a host device, and the data portion corresponds to a host version information; and an update trigger signal is generated by the first controller according to the external version information and the host version information, and an application is triggered to update the data portion by the update trigger signal.

The data management device of the disclosure includes a first controller and a storage circuit. The first controller is configured to be coupled to a storage device to receive an external version information. The storage circuit includes a data portion and a host version information. The external version information and the host version information correspond to the data portion. The first controller is further configured to generate an update trigger signal according to the external version information and the host version information, and an application is triggered to update the data portion by the update trigger signal.

Based on the above, the data management device and the data management method of the disclosure, the interaction between the device and a program group may be controlled so that when an external version information is received from an external storage device, an data update may be timely and automatically executed without manually updating the data.

### BRIEF DESCRIPTION OF THE DRAWINGS

FIG. 1 is a schematic diagram of a data management mechanism according to various embodiments of the disclosure.

FIG. 2 is a schematic diagram of a data management device and an external storage device applicable thereto according to an embodiment of the disclosure.

FIG. 3 is a schematic diagram of operation of a data management method according to an embodiment of the disclosure.

FIG. 4 is a flow chart of a data management method according to an embodiment of the disclosure.

### DESCRIPTION OF THE EMBODIMENTS

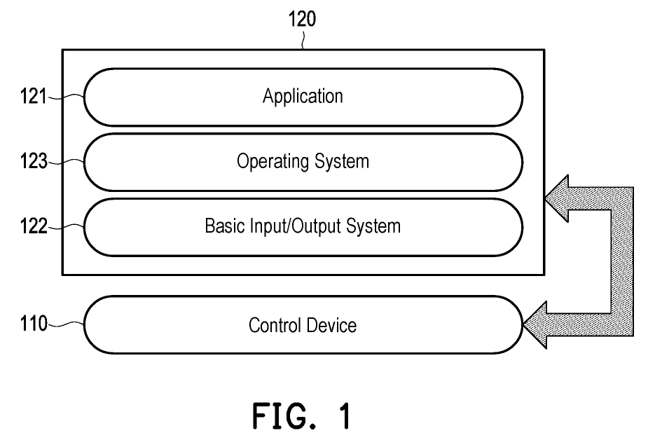

Please refer to FIG. 1 below. FIG. 1 is a schematic diagram of a data management mechanism according to various embodiments of the disclosure. As shown in FIG. 1, the data management mechanism of the disclosure automatically performs a data update through the interaction between a control device 110 and a program group 120. The control device 110 may include at least one controller. Furthermore, the program group 120 may include at least an application 121 configured to execute the data update. In some embodiments, the program group 120 may further include a basic input/output system (BIOS) 122 and/or an operating system (OS) 123.

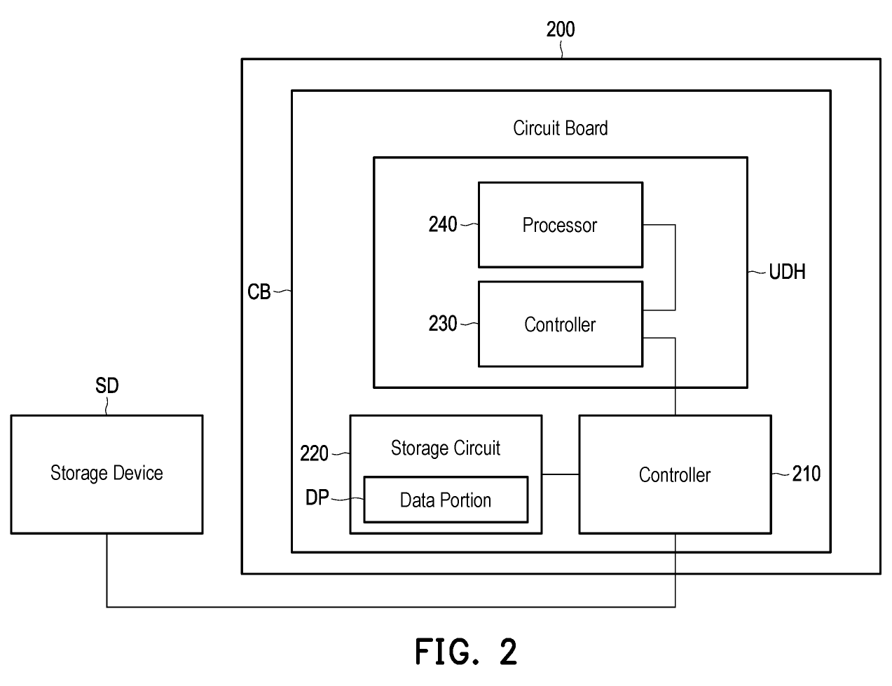

Please refer to FIGS. 1 and FIG. 2 together below. FIG. 2 is a schematic diagram of a data management device 200 and an external storage device SD applicable thereto according to an embodiment of the disclosure. The data management device 200 may serve as a host device. The data management device 200 includes a controller 210 and a storage circuit 220. The controller 210 and the storage circuit 220 are coupled to each other. The controller 210 is also configured to be coupled to the storage device SD. In the embodiment, the storage device SD may generate an electrical connection with the controller 210 in any form with no specific limitations. For example, the storage device SD may be a portable solid state drive (PSSD) or a pen drive. As another example, the storage device SD may also be a cloud drive. The storage device SD has an external version information corresponding to a data portion DP stored by the storage circuit 220 in the host device. In addition, in some embodiments, the storage device SD further has data identified by the external version information. In the embodiment of the disclosure, the controller 210 obtains the external version information corresponding to the data portion DP stored in the storage circuit 220 through reading the storage device SD.

In addition, in some embodiments, the storage circuit 220, in addition to be configured to store the data portion DP, also stores a host version information corresponding to the stored data portion DP. The host version information is configured to identify the data portion DP. In other embodiments, the controller 210 itself has a storage function. The host version information is stored in the controller 210 instead of in the storage circuit 220. In addition, in some embodiments, when a setup time of the data identified by the external version information is later than a setup time of the data portion DP, the data identified by the external version information is configured to serve as updated data to replace the data portion DP.

On the other hand, the storage circuit 220 may further include other data besides the foregoing data portion DP. Specifically, the storage circuit 220 may be a random-access memory (RAM), ROM or an internal hard drive with no specific limitations.

In addition, in operation, the controller 210 may generate an update trigger signal according to the external version information and the host version information. The update trigger signal is configured to trigger the application 121 in FIG. 1 to update the foregoing data portion DP.

In addition, in the embodiment, the data management device 200 may further include an update device UDH. The update device UDH is configured to execute an operation of data update in response to the foregoing update trigger signal. Specifically, the update device UDH includes a controller 230. The controller 230 is coupled to the controller 210. In operation, the controller 230 transmits a data update command to the application 121 in response to the update trigger signal.

In addition, in the embodiment, the update device UDH may further include a processor 240. The processor 240 is coupled to the controller 230. The processor 240 is configured to drive the program group 120 in FIG. 1 to transmit the data update command from the controller 230 and perform an update on the data portion DP. For example, the processor 240 drives a basic input/output system 122 to transmit the data update command to the operating system 123. For example, the processor 240 drives the operating system 123 to transmit the data update command to the application 121. For example, the processor 240 drives the application 121 to update the foregoing data portion DP in response to the data update command.

In some embodiments, the controllers 210 and 230 may be constructed by any form of digital circuits with no specific limitations. The processor 240 may be a central processing unit (CPU), micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA) or other similar elements with no specific limitations.

Incidentally, the controller 210 and the storage circuit 220 and/or the update device UDH in the data management device 200 may be disposed on a circuit board CB. In the embodiment, the circuit board CB may be various circuit boards well-known to those skilled in the art, such as printed circuit board (PCB) or printed circuit board assembly (PCBA).

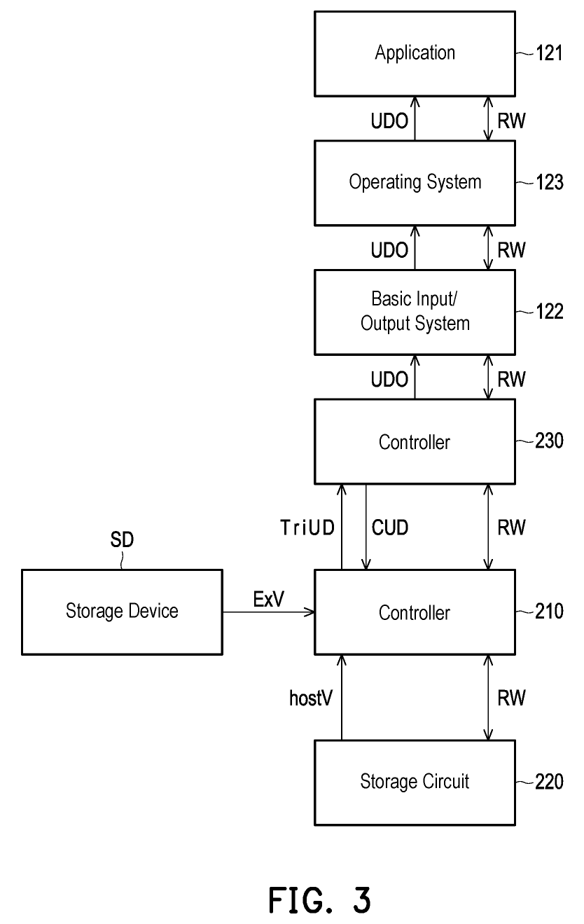

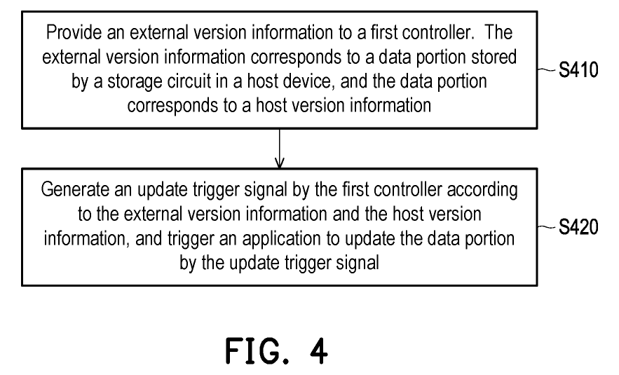

Please refer to FIGS. 2, FIG. 3, and FIG. 4 together below. FIG. 3 is a schematic diagram of operation of a data management method according to an embodiment of the disclosure. FIG. 4 is a flow chart of a data management method according to an embodiment of the disclosure. In step S410, an external version information ExV is provided to the controller 210. The external version information ExV corresponds to the data portion DP stored by the storage circuit 220, and the data portion DP corresponds to a host version information hostV. In step S420, an update trigger signal TriUD is generated by the controller 210 according to the external version information ExV and the host version information hostV, and the application 121 is triggered to update the data portion DP by the update trigger signal TriUD.

In detail, step S401 may be executed by the following steps: the controller 210 is allowed to generate the update trigger signal TriUD by comparing a version date of the external version information ExV with a version date of the host version information hostV.

In more detail, in some embodiments, the external version information ExV includes a setup time of the data identified by the external version information ExV. The host version information hostV includes a setup time of the data portion DP. The setup time may be the version date. When the version date of the external version information ExV is later than the version date of the host version information hostV, the update trigger signal TriUD is determined to be generated.

In addition, in the embodiment, the storage device SD may provide the external version information ExV through an electrical connecting line or a communication network. Those skilled in the art may set the manner for the storage device SD to provide the external version information ExV according to actual needs or hardware specifications of the data management device 200 with no specific limitations.

In addition, in the embodiment, the host version information hostV may be provided to the controller 210 by the storage circuit 220. Alternatively, when the storage circuit 220 stores the data portion DP, the controller 210, which has its own storage function, records the host version information hostV. Those skilled in the art may set the elements providing the host version information hostV according to actual needs or hardware specifications of the data management device 200 with no specific limitations.

In addition, in the embodiment, the update trigger signal TriUD may be written in a language understandable by the application 121. In this way, the update trigger signal TriUD may be directly transmitted from the controller 210 to the application 121. The application 121 may perform an update on the data portion DP in the storage circuit 220 through a read/write path RW in response to the update trigger signal TriUD. Here, the read/write path RW is a data transmission path when the application 121 executes a read/write operation on the storage circuit 220. As shown in FIG. 3, the read/write path RW is bidirectional. When the application 121 reads certain data (such as the data portion DP) from the storage circuit 220, the data portion DP is transmitted from the storage circuit 220 to the application 121 through the read/write path RW. When the application 121 writes updated data identified by the external version information ExV to the storage circuit 220 to overwrite the data portion DP (that is, to update the data portion DP), the updated data is transmitted to the storage circuit 220 through two implementations involving the read/write path RW. In one implementation, the updated data is transmitted from the application 121 to the storage circuit 220 through the read/write path RW. In another implementation, the updated data is first transmitted from the storage device SD to the controller 210. Next, the application 121 drives the controller 210 to transmit the updated data to the storage circuit 220 through the read/write path RW.

On the other hand, when the update trigger signal TriUD is not written in a language understandable by the application 121, after the data management device 200 is restarted, the controller 230 may transmit a data update command UDO to the application 121 through at least one system program (such as the basic input/output system 122 and the operating system 123) in response to the update trigger signal TriUD.

For example, after the data management device 200 is restarted, the basic input/output system 122 may receive the data update command UDO from the controller 230. Next, the operating system 123 may receive the data update command UDO from the basic input/output system 122 and transmit the data update command UDO to the application 121.

Next, the application 121 may execute the update on the data portion DP in response to the data update command UDO.

In the embodiment, after the application 121 completes updating the data portion DP, the controller 230 may transmit an update completion signal CUD to the controller 210. Next, the controller 210 retracts the update trigger signal TriUD in response to the update completion signal CUD. In this way, after the data management device 200 is restarted, related operations of the foregoing controller 230, the application 121, the basic input/output system 122, and the operating system 123 may not be executed again, thereby ending the data update.

Please refer to FIG. 1 again, and refer to FIG. 2 together. It is worth noting that the foregoing data management method involves the controller 210, and may further involve the controller 230. Therefore, the control device 110 in FIG. 1 at least includes the controller 210, and in some embodiments, may further include the controller 230. In the data management mechanism of the disclosure, the data portion DP in the storage circuit 220 is updated through the interaction between the controller 210 and the application 121. Alternatively, the data portion DP in the storage circuit 220 is updated through the interaction of the controller 210 and the controller 230 with the program group 120.

In summary, the data management device and the data management method of the disclosure, the data in the host device may be timely and automatically updated through the interaction between the control device and the program group, which solves the problem in the known technology where data in the storage circuit of the host device needs to be manually updated, causing inconvenience to the user.

What is claimed is:

1. A data management method, comprising:
providing an external version information to a first controller, wherein the external version information corresponds to a data portion stored by a storage circuit in a host device, and the data portion corresponds to a host version information; and
generating an update trigger signal by the first controller according to the external version information and the host version information, and triggering an application to update the data portion by the update trigger signal.

2. The data management method according to claim 1, wherein steps of generating the update trigger signal according to the external version information and the host version information comprise:
allowing the first controller to generate the update trigger signal through comparing a version date of the external version information with a version date of the host version information.

3. The data management method according to claim 2, wherein steps of allowing the first controller to generate the update trigger signal by comparing the version date of the external version information with the version date of the host version information comprise:
determining to generate the update trigger signal when the version date of the external version information is later than the version date of the host version information.

4. The data management method according to claim 1, further comprising:
providing the host version information to the first controller by the storage circuit.

5. The data management method according to claim 1, further comprising:
transmitting a data update command to the application through at least one system program by a second controller in response to the update trigger signal after the host device is restarted; and
executing an update on the data portion by the application in response to the data update command.

6. The data management method according to claim 5, wherein steps of transmitting the data update command to the application through the at least one system program by the second controller comprise:
receiving the data update command from the second controller by a basic input/output system.

7. The data management method according to claim 6, wherein the steps of transmitting the data update command to the application through the at least one system program by the second controller further comprise:
receiving the data update command from the basic input/output system by an operating system, and transmitting the data update command to the application.

8. The data management method according to claim 5, further comprising:
transmitting an update completion signal to the first controller by the second controller after the application completes updating the data portion; and
retracting the update trigger signal by the first controller in response to the update completion signal.

9. A data management device, comprising:
a first controller, configured to be coupled to a storage device to receive an external version information; and
a storage circuit, comprising a data portion and a host version information, wherein the external version information and the host version information correspond to the data portion,
wherein the first controller is further configured to generate an update trigger signal according to the external version information and the host version information, and an application is triggered to update the data portion by the update trigger signal.

10. The data management device according to claim 9, further comprising:
a second controller, coupled to the first controller, and configured to transmit a data update command to the application in response to the update trigger signal.

11. The data management device according to claim 10, wherein the second controller is further configured to transmit an update completion signal to the first controller when the application completes updating the data portion, and the first controller is further configured to retract the update trigger signal in response to the update completion signal.
